(19) United States
(12) Patent Application Publication
(10) Pub. No.: US 2018/0029795 A1
(43) Pub. Date: Feb. 1, 2018

(54) Single Arm Lifter Assembly For Intermediate Refuse Collection Container

(71) Applicant: Perkins Manufacturing Co., Romeoville, IL (US)

(72) Inventor: Carlos Arrez, Berwyn, IL (US)

(21) Appl. No.: 15/646,232

(22) Filed: Jul. 11, 2017

Related U.S. Application Data
(60) Provisional application No. 62/368,493, filed on Jul. 29, 2016.

(51) Int. Cl. B65F 3/04

(52) U.S. Cl. CPC B65F 3/041; B65F 2003/0279

(57) ABSTRACT

A lifter assembly is provided for engaging or capturing a residential refuse collection cart spaced laterally from an associated intermediate container and for emptying the contents of the residential refuse collection cart into the intermediate. The lifter assembly includes a base configured to be secured to the intermediate container, a first elongated member (or mast) having a first end pivotably mounted to the base and a second end pivotably connected to the first end of a second elongated member (or “flipper”). A cart gripper assembly is rotatably mounted to the second end of the second elongated member for selectively gripping and releasing a residential refuse collection container.

The present application is directed to a single arm lifter assembly for an intermediate refuse collection container for front loaded trucks for use in garbage collection.

Front-loading refuse collection systems are in wide use in the collection of residential refuse. Such systems typically include a heavy-duty truck having a large hopper or bin located behind the cab for receipt of refuse. An intermediate container is carried in front of the cab on lift arms that move the intermediate container from an upright position forward of the cab to an inverted position behind the cab and over the hopper to receive refuse that is collected in the intermediate container.

Associated with the intermediate container is a mechanism for engaging a residential refuse collection cart spaced laterally from the intermediate container, and dumping its contents into the intermediate container. Representative examples of such systems are generally shown and described in, e.g., Zopf U.S. Pat. No. 5,607,277 and Christenson U.S. Pat. No. 5,938,394.

Such systems are typically configured so that the residential cart engaging mechanism is able to capture and dump residential carts located only on one side of the intermediate container, i.e., the curb-side or right-hand side of the collection vehicle/intermediate container. Thus, in a typical collection route, the collection vehicle will move in a first direction to collect refuse from one side of the street, and then in a reverse direction to collect refuse from the other side. However, there are situations (such as in narrow streets or alleys or on one-way streets) in which it would be advantageous for the collection vehicle to be able to collect refuse from both sides of the collection container in a single pass.

### SUMMARY

By way of the present application, a refuse collection system is provided in which a single cart engagement mechanism will capture and dump the contents of residential collection carts located on both sides of the intermediate container in a single pass of the refuse collection vehicle.

In a first aspect of the invention, a lifter assembly for engaging or capturing a residential refuse collection cart spaced laterally from an associated intermediate container and for emptying the contents of the residential refuse collection cart into the intermediate is provided. The lifter assembly comprises a base configured to be secured to the intermediate container; a first elongated member (or mast) having a first end and a second end, the first end being pivotably mounted to the base; a second elongated member (or “flipper”) having a first end and a second end, the first end of the second elongated member being pivotably attached to the second end of the first elongated member; and a gripper assembly for selectively gripping and releasing a residential refuse collection container, the gripper assembly being rotatably mounted to the second end of the second elongated member.

The lifter assembly further comprises a first actuator assembly interposed between the base and an intermediate portion of the first elongated member; a second actuator assembly interposed between the intermediate portion of the first elongated member and an intermediate portion of the second elongated member; and a third actuator assembly secured to the second end of the second elongated member for rotating the gripper assembly about the second end of the second elongated member.

In another aspect, each of the first and second actuator assemblies comprises a cylinder and a piston. In a further aspect, the first actuator assembly further comprises first and second intermediate links pivotably connected to each other, the first intermediate link also being pivotably connected to the base and the second intermediate link also being pivotably connected to the intermediate portion of the first elongated member.

In a related aspect, the first end of the first elongated member is pivotably mounted to the base so as to be pivotable about a substantially horizontal first axis and the first elongated member is movable in a substantially vertical first plane, and the first end of the second elongated member is pivotably connected to the second end of the first elongated member about a substantially horizontal second axis and the second elongated member is movable in a substantially vertical second plane, the first plane and the second plane being generally co-planar.

In a further aspect, the first actuator assembly provides for approximately 165° of pivotal movement of the first elongated member relative to the base; the second actuator assembly provides for approximately 270° of pivotal movement of the second elongated member relative to the second end of the first elongated member, and the third actuator assembly provides for approximately 360° of rotation of the gripper assembly relative to the second end of the second elongated member.

In another aspect, the lifter assembly is part of a system including the intermediate container and the refuse collection vehicle. The lifter assembly may be mounted adjacent to either the front wall or the rear wall of the intermediate container.

### BRIEF DESCRIPTION OF THE DRAWINGS

FIG. 1 is an exploded perspective view of a first embodiment of a lifter assembly according to the present application in combination with an intermediate container and a collection truck.

FIG. 2 is a front view of the lifter assembly of FIG. 1 in combination with an intermediate collection container with the arm assembly in a first position with the cart gripper assembly extending outwardly from the left-hand side of the intermediate container.

FIG. 3 is a front view of the lifter assembly similar to FIG. 2 showing the arm assembly in an intermediate position as it moves the cart gripper assembly from the left-hand side of the intermediate container to the right-hand side.

FIG. 4 is a front view of the lifter assembly similar to FIG. 2 except showing the cart gripper assembly extending toward the right-hand side of the intermediate container.

FIG. 5 is a top perspective view of the first embodiment of the lifter assembly in combination with an intermediate collection container with the arm assembly with the cart gripper assembly extending outwardly from the left-hand side of the intermediate container, similar to FIG. 2.

FIG. 6 is a perspective view of the first embodiment of the lifter assembly in combination with an intermediate container and a collection truck with the lift arm in a retracted/storage position prior to extending and capturing a residential refuse collection cart located on the right-hand side of the intermediate container/collection truck.

FIG. 7 is a perspective view of the first embodiment of the lifter assembly in combination with an intermediate container and a collection truck with the lift arm in a retracted/dumping position after having captured a residential refuse collection cart located on the right-hand side of the intermediate container/collection truck.

FIG. 8 is a perspective view of the first embodiment of the lifter assembly in combination with an intermediate container and a collection truck with the lift arm in a retracted/dumping position after having captured a residential refuse collection cart located on the left-hand side of the intermediate container/collection truck.

FIG. 9 is an exploded perspective view of a second embodiment of a lifter assembly according to the present application in combination with an intermediate container and a collection truck.

FIG. 10 is a top perspective view of the second embodiment of the lifter assembly in combination with an intermediate collection container with the arm assembly with the cart gripper assembly extending outwardly from the left-hand side of the intermediate container.

### DETAILED DESCRIPTION

The embodiments disclosed herein are for the purpose of providing an exemplary description of the present subject matter. They are, however, only exemplary, and the present subject matter may be embodied in various forms. Therefore, specific details disclosed herein are not to be interpreted as limiting the subject matter as defined in the accompanying claims.

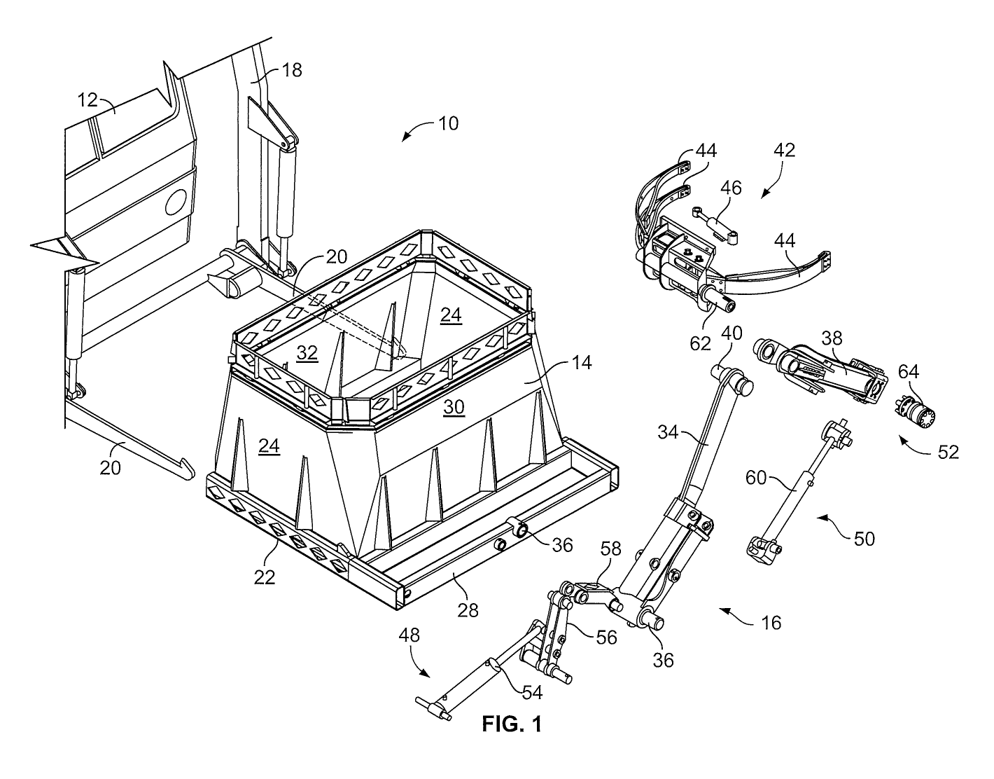

With reference to FIGS. 1 and 6-8 there is seen a refuse collection system, generally indicated 10, comprising a truck 12, an intermediate collection container 14, and a single-arm lifter assembly 16 in accordance with the present application. In FIGS. 1 and 6-8, only the front portion of the cab of the truck 12 is shown.

As is well known, the truck 12 has a pair of lift arms 18 that carry means for releasably securing the intermediate container 14 to the lift arms, such as a pair of forks 20 that are receivable in elongated pockets 22 located along the bottom of the opposed side walls 24 of the container 14. The lift arms 18 are movable from a first position, as shown in FIGS. 1 and 6-8, in which the intermediate container is carried in an upright position forward of the cab, to a second position (not shown) in which the intermediate container is lifted over the cab and inverted, to dump its contents into a large collection hopper mounted on the chassis of the truck 12 rearwardly of the cab.

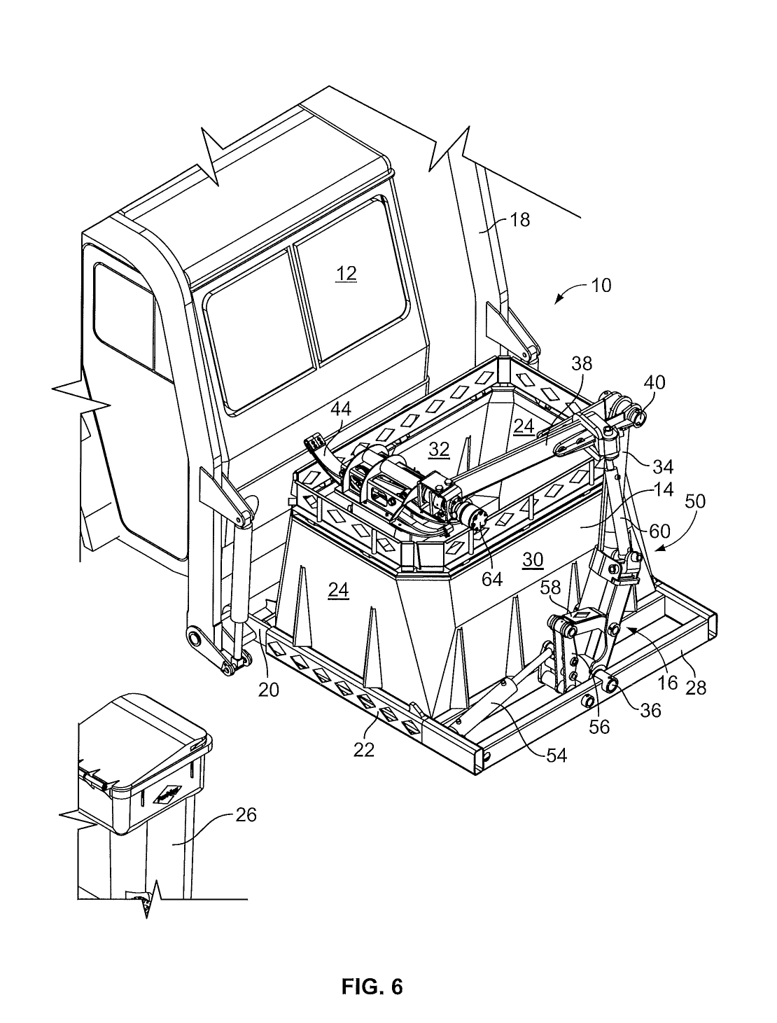

In keeping with the disclosure, the lifter assembly 16 is configured to releasably engage and invert residential refuse collection carts, such as the cart 26 shown in FIGS. 6-8, located on either the right-hand or left-hand sides of the intermediate container 14. The lifter assembly 16 comprises a single arm having two elongated members pivotably attached to each other, and one of which is pivotably attached to the base 28, with a cart gripper assembly carried at the free end of elongated members. Actuators are provided for moving and extending the cart gripper assembly to opposite sides of the intermediate container 14, thus permitting the assembly to engage and retrieve a residential cart located on either side of the intermediate container and to then invert the residential cart to dump its contents into the intermediate container.

Returning to the drawings, the lifter assembly 16 comprises a base bracket or weldment 28 which, as illustrated, is mounted to the bottom of the front wall 30 of the intermediate container 14. (When the term “weldment” is used in the present description, it is not meant to limit the structures to which it refers to those formed by welding together an assembly of pieces, but is more generally understood to refer to a unitary structure formed in any manner that would occur to a person skilled in the metal fabricating art.) As can be appreciated, the base bracket 28 can alternatively be mounted to the bottom of the rear wall 32 of the intermediate container. As illustrated, the base 28 comprises a plurality of box beams having a rectangular configuration, with an open central region.

The lifter assembly comprises a first elongated member or mast weldment 34 having its first end secured to the base 28 by a first pivot connection 36, a second elongated member or flipper weldment 38 having its first end secured to the second end of the mast weldment 34 by a second pivot connection 40; and a residential cart gripper assembly 42 rotatably connected to the second end of the flipper weldment. As illustrated, the residential cart gripper assembly 42 comprises opposed arm members 44 that are movable by means of a hydraulic piston/cylinder 46 between an open position (for storage and releasing a collection cart) and a closed position (for engaging a collection cart). An exemplary cart gripper assembly is shown and described in U.S. Pat. No. 7,390,159, having a common assignee as the present application, and which is incorporated herein by reference.

The pivot connections 36 and 40 are oriented such that both the mast weldment 34 and the flipper weldment 38 are pivotable about substantially horizontal axes and movable in substantially vertical planes. Preferably the planes in which the mast weldment 34 and flipper weldment 38 pivot are coplanar, which provides for a more compact operation of the lifter assembly. In addition, the gripper assembly 42 is rotatably mounted to flipper weldment 38 so as to be rotatable about a substantially horizontal axis generally parallel to the pivot axes of the mast weldment 43 and flipper weldment 38.

Actuator assemblies provided for moving each of the mast weldment 34, flipper weldment 38, and gripper assembly 42 relative to each other to provide a range of motion sufficient to retrieve and return residential collection carts located on either side of the intermediate container 14, and to dump the contents of such collection carts into the intermediate container. In the illustrated embodiment, a first actuator assembly 48 provides for approximately 165° of pivotal movement between the base 28 and the mast weldment 34, a second actuator assembly 50 provides for approximately 270° of pivotal movement between the mast weldment 34 and the flipper weldment 38, and a third actuator assembly 52 provides for approximately 360° of rotational movement between the flipper weldment 38 and the gripper assembly 42.

As illustrated, the actuator assembly 48 comprises a cylinder/piston combination 54 that is pivotably connected on one end to the base 28 and pivotably connected on its other end to an end of a lower link 56, the lower link 56 being pivotably connected its other end to the base 28. An upper link 58 is pivotably connected to intermediate portions of both the lower link 56 and the mast weldment 34. Movement of the mast weldment 34 from one side of the intermediate container 14 to the other is caused by the extension/retraction of the cylinder/piston 54, to push/pull the lower link 56/upper link 58.

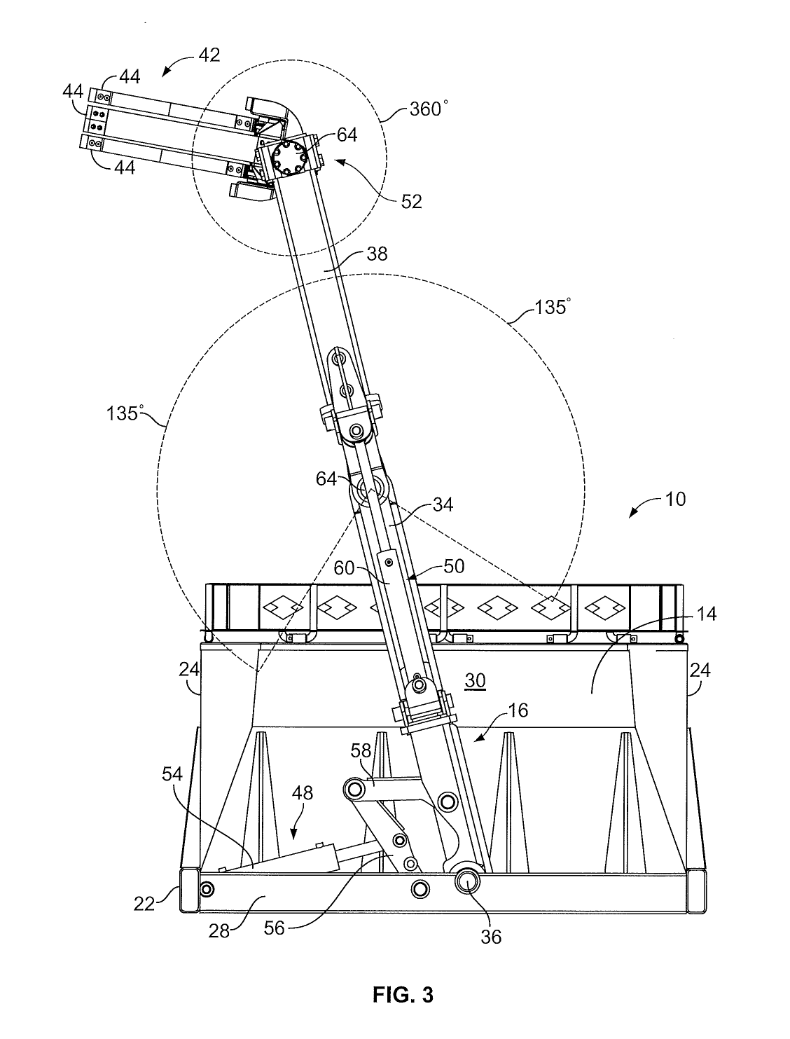

Actuator assembly 50, as illustrated, also comprises a cylinder/piston combination 60 pivotably connected on one end to an intermediate portion of the mast weldment 34 and pivotably connected on its other end to an intermediate portion of the flipper weldment 38. The actuator assembly 50 pushes the flipper weldment 38 until the end of the cylinder travel, at which point the flipper weldment 38 will be substantially collinear with the mast weldment 34, as seen, e.g., in FIG. 3. Thus, a flipping effect will occur when the mast weldment 34 and the flipper weldment 38 are substantially collinear, and the mast weldment 34 is directed towards the desired side of the intermediate container 14 to position the gripper assembly 42 for engagement/return and release of a residential collection cart 26, with the weight of the gripper assembly 42 helping to move the flipper weldment 38 in a downward direction.

Actuator assembly 52 is attached to the upper end of the flipper weldment 38. The assembly 52 comprises a rotatable tube weldment 62 extending from and integral with the gripper assembly 42, with a hydraulic motor 64 configured to be connected to the tube weldment 62 for rotating the gripper assembly 42. The hydraulic motor 64 has the capability to rotate the gripper assembly 42 through approximately 360° relative to the flipper weldment 38. This permits the gripper assembly 42 to face outwardly, with its face perpendicular to the ground for engaging and releasing a refuse cart positioned on either side of the intermediate container, and further to maintain proper orientation of the cart and invert the cart to dump its contents into the intermediate container 14.

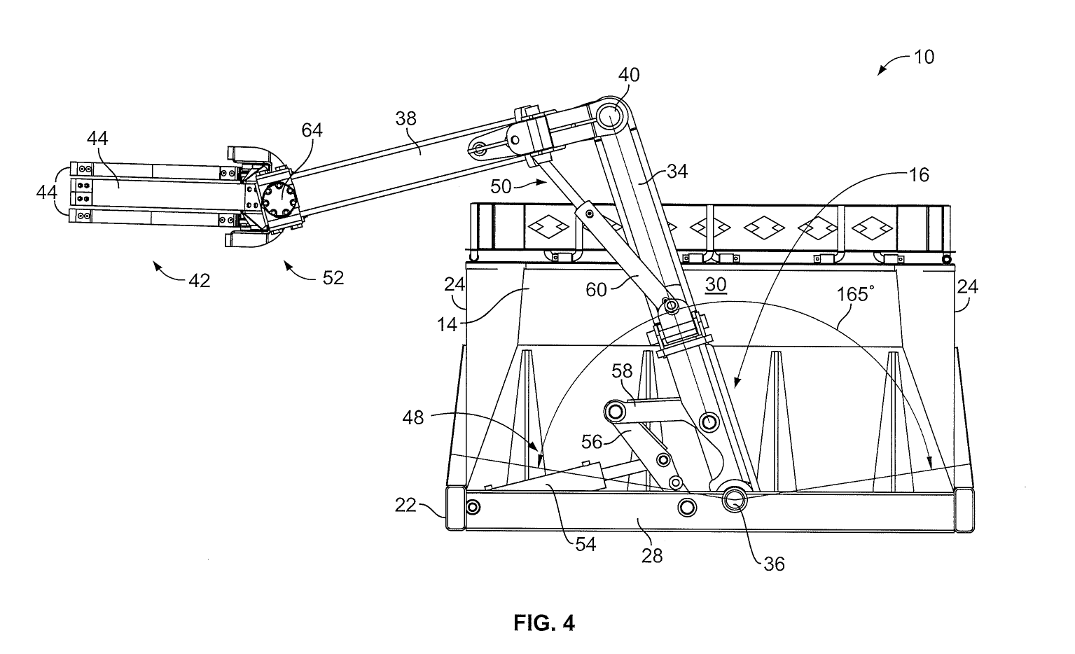

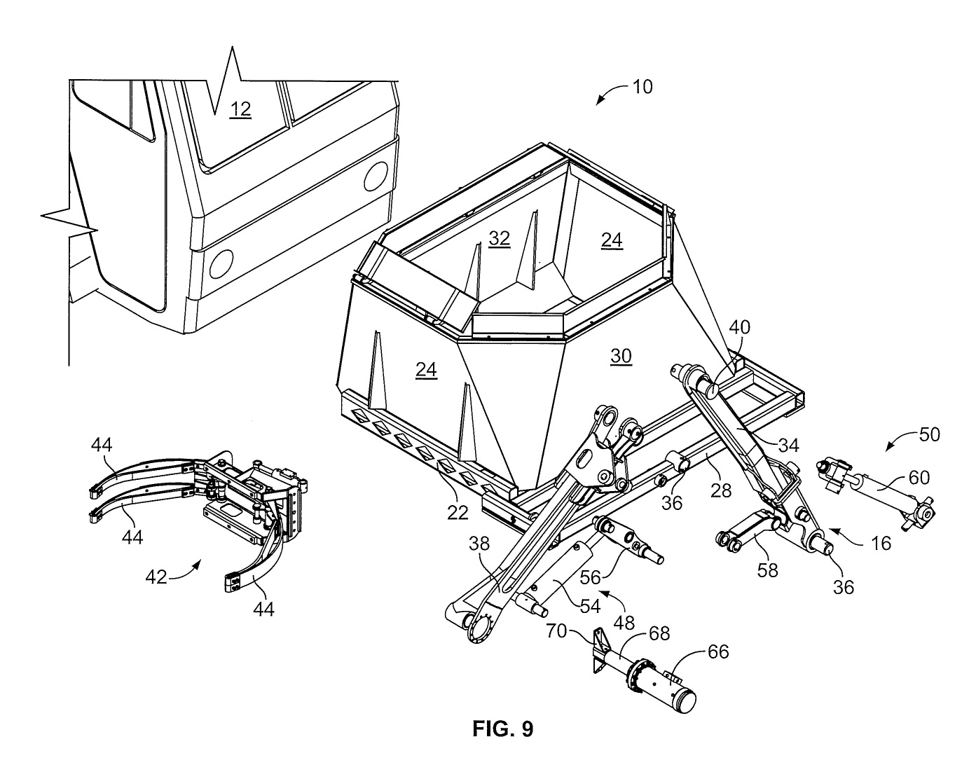

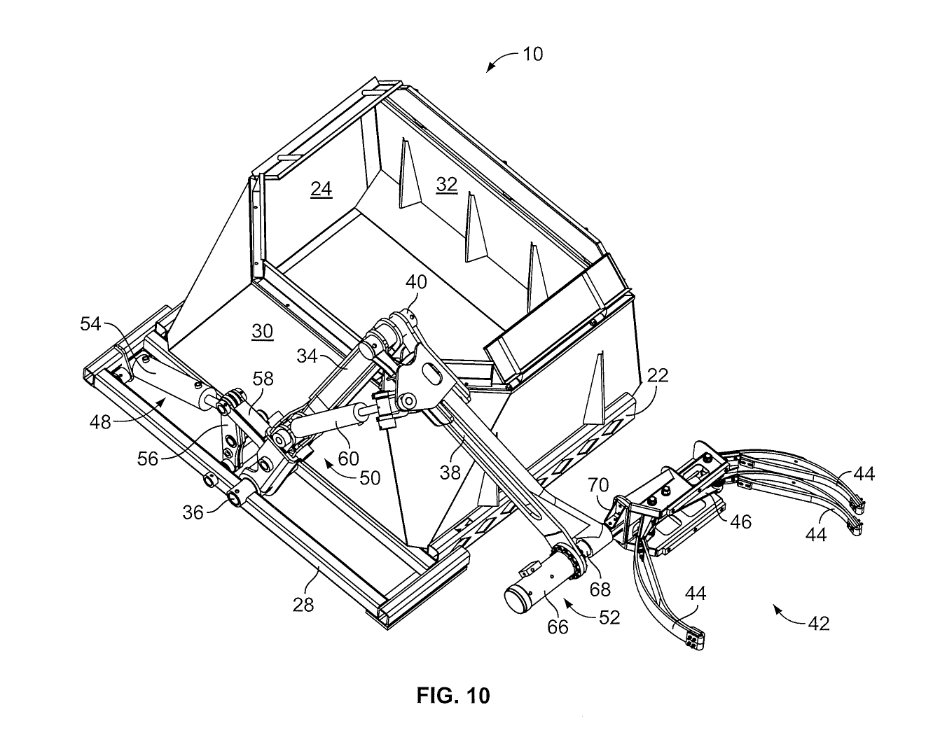

In an alternate embodiment, shown in FIGS. 9 and 10, the actuator assembly comprises a hydraulic actuator 66 that is rotatable in either direction without stop. A shaft 68 is secured to the hydraulic actuator 66 that has a bracket 70 at its end that is configured to be fastened to the gripper mechanism 42. The embodiment of FIGS. 9 and 10 also differs from that of FIGS. 1-8 in that the mast weldment 34 and flipper weldment 38 are of a more robust construction. Otherwise, the embodiments are functionally the same.

As can be appreciated, when gripping mechanism 42 is to be moved from one side of the intermediate container 14 to the other, the flipper weldment 38 has pass through a substantially collinear position with respect to the mast weldment 34, and thus flipped to the other side, by extending the cylinder/piston arrangement to its full extent of travel. Once the mast weldment 34 and flipper weldment 38 are collinear, and pass through being perpendicular to the ground, the weight and gravity of the gripper mechanism are moved over center, and thus assist downward movement the other direction.

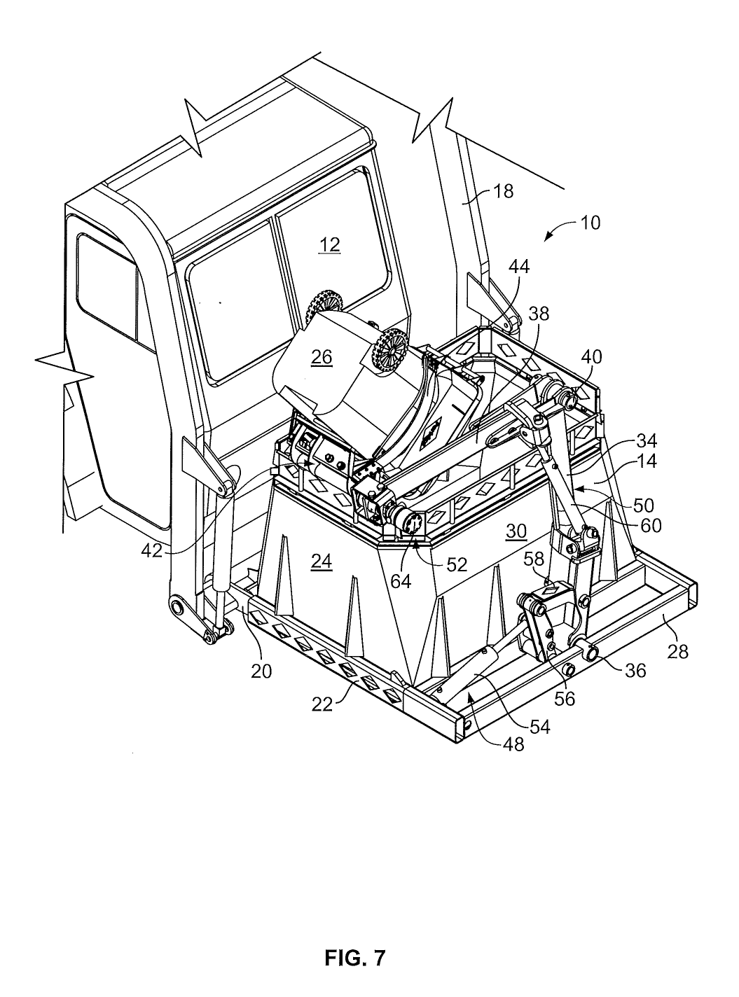

To collect refuse from a cart located on the right-hand side of the intermediate container 14 (as viewed from the cab of the collection vehicle), the mast weldment 34 and flipper weldment 38 are moved from the retracted/storage position shown in FIG. 6 to the cart engaging position by retracting the cylinder/piston arrangement of actuator 48 while extending the cylinder/piston arrangement of actuator 50. The lift assembly is then retracted for dumping the cart by extending the cylinder/piston arrangement of actuator 48 and retracting the cylinder/piston of actuator 50, to achieve the position shown in FIG. 7.

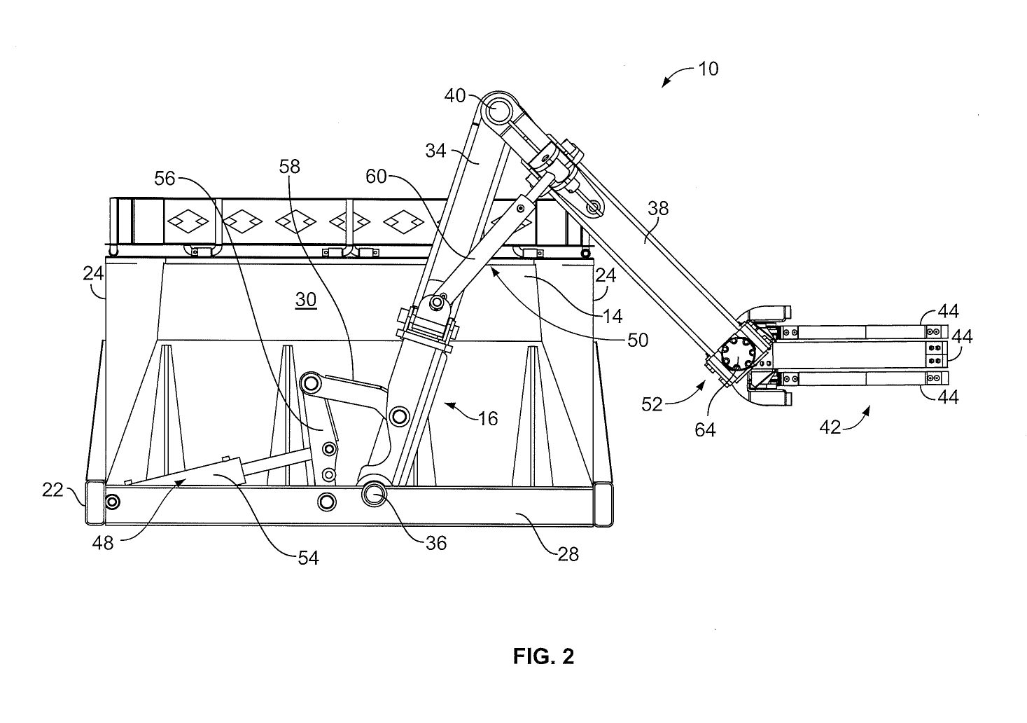

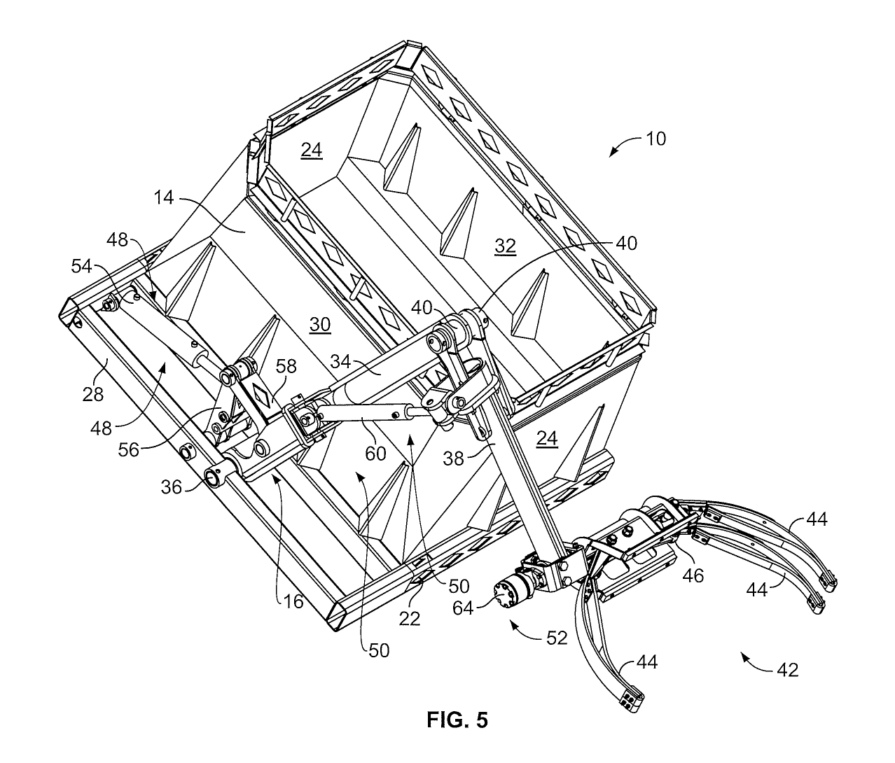

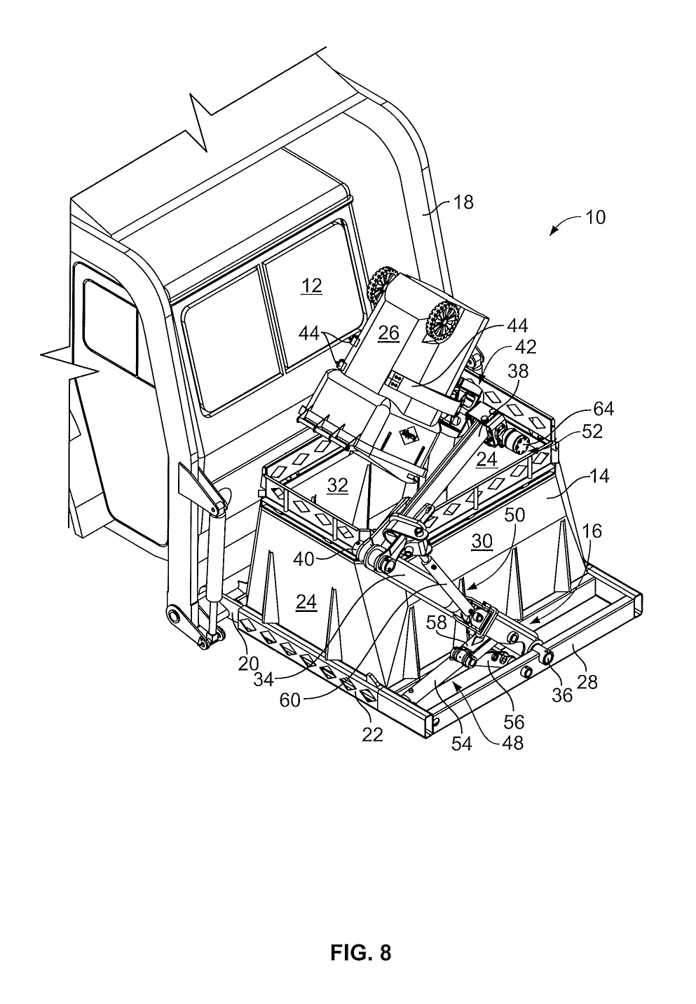

With reference to FIG. 6, the lifter assembly 16 is shown in its retracted or storage position. To collect the refuse from a cart located on the left-hand side of the intermediate container 14 (again, as viewed from the cab of the collection vehicle), the cylinder/piston combinations of actuator 48 is lengthened, while cylinder/piston arrangement of actuator 50 is first lengthened so that the flipper weldment 38 is substantially collinear with the mast weldment 34 (as seen in FIG. 3), thus flipping the flipper weldment from the right-hand side to the left hand side. Then, the cylinder/piston arrangement of actuator 50 is retracted to position the gripper assembly 42 as shown in FIGS. 2 and 5. The cylinder/piston arrangement of actuator 50 can then be extended to move the gripper assembly 42 toward a collection cart. Once the collection cart is engaged, the lifter assembly is then retracted to position the cart over the intermediate container for dumping, as seen in FIG. 8.

Thus, a residential refuse cart lifter assembly has been provided that can empty refuse from collection carts positioned on opposite sides of an associated intermediate collection container. While the lifter assembly has been described in terms of certain specific embodiments, the specific details disclosed herein are not to be interpreted as limiting the subject matter as defined in the accompanying claims.

I claim:

1. A lifter assembly for a residential refuse collection cart for emptying the contents of the residential refuse collection cart into an associated intermediate container of the type configured to be carried in front of a collection vehicle, the lifter assembly comprising:
a) a base configured to be secured to the intermediate container;
b) a first elongated member having a first end and a second end, the first end being pivotably mounted to the base;
c) a second elongated member having a first end and a second end,
the first end of the second elongated member being pivotably attached to the second end of the first elongated member;
d) a gripper assembly for selectively gripping and releasing a residential refuse collection container, the gripper assembly being rotatably mounted to the second end of the second elongated member;
e) a first actuator assembly interposed between the base and an intermediate portion of the first elongated member;
f) a second actuator assembly interposed between the intermediate portion of the first elongated member and an intermediate portion of the second elongated member; and
g) a third actuator assembly secured to the second end of the second elongated member for rotating the gripper assembly about the second end of the second elongated member.

2. The lifter assembly of claim 1 wherein each of the first and second actuator assemblies comprises a cylinder and a piston.

3. The lifter assembly of claim 2 wherein the first actuator assembly further comprises first and second intermediate links pivotably connected to each other, the first intermediate link also being pivotably connected to the base and the second intermediate link also being pivotably connected to the intermediate portion of the first elongated member.

4. The lifter assembly of claim 1 wherein the first elongated member is pivotally connected to a central portion of the base.

5. The lifter assembly of claim 1 wherein the first end of the first elongated member is pivotably mounted to the base so as to be pivotable about a substantially horizontal first axis and the first elongated member is movable in a substantially vertical first plane; and the first end of the second elongated member is pivotably connected to the second end of the first elongated member about a substantially horizontal second axis and the second elongated member is movable in a substantially vertical second plane; the first plane and the second plane being generally co-planar.

6. The lifter assembly of claim 5 wherein the gripper assembly is rotatably mounted to the second end of the second elongated member so as to be rotatable about a substantially horizontal third axis generally parallel to both the first axis and the second axis.

7. The lifter assembly of claim 6 wherein the first actuator assembly provides for approximately 165° of pivotal movement of the first elongated member relative to the base; the second actuator assembly provides for approximately 270° of pivotal movement of the second elongated member relative to the second end of the first elongated member, and the third actuator assembly provides for approximately 360° of rotation of the gripper assembly relative to the second end of the second elongated member.

8. The lifter assembly of claim 1 wherein the third actuator assembly comprises a rotatable hydraulic motor and the gripper assembly comprises shaft that is secured to the hydraulic motor.

9. The lifter assembly of claim 1 wherein the third actuator assembly comprises a rotatable shaft extending therefrom and having a bracket integral therewith the gripper assembly being fastened to the bracket.

10. A collection system for residential refuse collection carts comprising:
a) a refuse collection vehicle;
b) an intermediate container having front, rear, right-hand, left-hand and bottom walls configured to be carried by the refuse collection vehicle;
c) a lifter assembly comprising:
d) a base configured to be secured to the intermediate container;
e) a first elongated member having a first end and a second end, the first end being pivotably mounted to the base;
f) a second elongated member having a first end and a second end, the first end of the second elongated member being pivotably attached to the second end of the first elongated member;
g) a gripper assembly for selectively gripping and releasing a residential refuse collection container, the gripper assembly being rotatably mounted to the second end of the second elongated member;
h) a first actuator assembly interposed between the base and an intermediate portion of the first elongated member;
i) a second actuator assembly interposed between the intermediate portion of the first elongated member and an intermediate portion of the second elongated member; and
j) a third actuator assembly secured to the second end of the second elongated member for rotating the gripper assembly about the second end of the second elongated member.

11. The collection system of claim 10 wherein each of the first and second actuator assemblies comprises a cylinder and a piston.

12. The collection system of claim 11 wherein the first actuator assembly further comprises first and second intermediate links pivotably connected to each other, the first intermediate link also being pivotably connected to the base and the second intermediate link also being pivotably connected to the intermediate portion of the first elongated member.

13. The collection system of claim 10 wherein the first elongated member is pivotally connected to a central portion of the base.

14. The collection system if claim 11 wherein the first end of the first elongated member is pivotably mounted to the base so as to be pivotable about a substantially horizontal first axis and the first elongated member is movable in a substantially vertical first plane; and the first end of the second elongated member is pivotably connected to the second end of the first elongated member about a substantially horizontal second axis and the second elongated member is movable in a substantially vertical second plane; the first plane and the second plane being generally co-planar.

15. The collection system if claim 14 wherein the gripper assembly is rotatably mounted to the second end of the second elongated member so as to be rotatable about a substantially horizontal third axis generally parallel to both the first axis and the second axis.

16. The collection system of claim 15 wherein the first actuator assembly provides for approximately 165° of pivotal movement of the first elongated member relative to the base; the second actuator assembly provides for approximately 270° of pivotal movement of the second elongated member relative to the second end of the first elongated member, and the third actuator assembly provides for approximately 360° of rotation of the gripper assembly relative to the second end of the second elongated member.

17. The collection system assembly of claim 10 wherein the third actuator assembly comprises a rotatable hydraulic motor and the gripper assembly comprises shaft that is secured to the hydraulic motor.

18. The collection system assembly of claim 10 wherein the third actuator assembly comprises a rotatable shaft extending therefrom and having a bracket integral therewith the gripper assembly being fastened to the bracket.

19. The collection system of claim 10 wherein the base of the lifter assembly is mounted adjacent the front wall of the intermediate container.

20. The collection system of claim 10 wherein the base of the lifter assembly is mounted adjacent the rear wall of the intermediate container.
